(19) United States
(12) Patent Application Publication
(10) Pub. No.: US 2014/0163834 A1
(43) Pub. Date: Jun. 12, 2014

(54) CONTROL SYSTEM AND METHOD OF ELECTRO-MECHANICAL BRAKE SYSTEM VEHICLE

(71) Applicant: HYUNDAI MOTOR COMPANY, Seoul (KR)

(72) Inventor: In Su Kim, Anyang (KR)

(73) Assignee: Hyundai Motor Company, Seoul (KR)

(21) Appl. No.: 13/873,704

(22) Filed: Apr. 30, 2013

(30) Foreign Application Priority Data
Dec. 11, 2012 (KR) 10-2012-0143264

(51) Int. Cl. B60T 13/74; B60T 17/22

(52) U.S. Cl. CPC B60T 13/746; B60T 17/22
USPC 701/70

(57) ABSTRACT

Disclosed herein is a control system and method for an EMB vehicle. In particular, an engine control unit (ECU) of the EMB is automatically initialized before a brake pedal signal is generated, by detecting a driver's intention to drive the vehicle and continuing to brake in a normal state when a failure of the EMB is allowed while a vehicle drives.

### CROSS-REFERENCE TO RELATED PATENT APPLICATION

This application claims the benefit of Korean Patent Application No. 10-2012-0143264, filed on Dec. 11, 2012 in the Korean Intellectual Property Office, the disclosure of which is incorporated herein in its entirety by reference.

### BACKGROUND

1. Field of the Invention

The present invention relates to a control system and method of an electro-mechanical brake system (EMB) vehicle, and more particularly, to a control system and method of an EMB vehicle, whereby an engine control unit (ECU) of the EMB may be automatically initialized before a brake pedal signal is generated, by detecting that a driver is intending to drive the vehicle and braking in a normal state when a failure of the EMB is allowed while a vehicle is being driven.

2. Description of the Related Art

In general, in hydraulic brakes, when a driver steps on a brake pedal, a hydraulic pressure is generated in a master cylinder, and the hydraulic pressure reaches calipers disposed on each of the wheels, and simultaneously, a brake pad pressurizes a disc in a vertical direction to perform a brake operation.

Accordingly, a vehicle is generally braked by generating a brake force by using a mechanical hydraulic brake. However, various types of electro-mechanical brake systems (EMBs) that generate a brake force via a rotative force of an electric motor, have been recently developed. EMBs do not use hydraulic pressure and thus are more eco-friendly. They have a faster response rate than that of the hydraulic brakes due to fast response characteristics of a motor, and an accurate torque of the motor can be known from a current sensor. Additionally, they can control each of brake forces of wheels independently and thus have high degree of accuracy.

Since EMBs operate in an electronic manner, unlike in the existing hydraulic brakes, an engine control unit (ECU) associated with each EMB should operate continuously so as to drive an EMB actuator appropriately. However, in some EMB vehicles, even when the EMB does not operate for a long time, as the case when the driver parks the vehicle for extended periods of time, the ECU of the EMB operates continuously and thus, power consumption increases. In addition, in EMB vehicles, when a failure occurs in the EMB while the vehicle is being driven, normal vehicle braking cannot be performed.

### SUMMARY

The present invention provides a control system and method for an electro-mechanical brake system (EMB) vehicle, whereby an EMB may be automatically initialized before a driver steps on a brake pedal, by detecting or determining a driver's intention to drive the vehicle so that an on/off mode of an engine control unit (ECU) of the EMB may be automatically set.

The present invention also provides a control method and system of an EMB vehicle, whereby, when a failure occurs in an EMB while the EMB vehicle is being driven, vehicle braking using the EMB may be continuously performed until the EMB vehicle stops so that EMB braking in a normal state where the failure of the EMB is allowed, may be performed.

According to an aspect of the present invention, there is provided a control method of an electro-mechanical brake system (EMB) vehicle, the control method including: detecting and determining a driver's intention to drive a vehicle; in response to determining that the driver is intending to drive the vehicle, starting initialization of an EMB and determining whether an EMB operable signal is generated; in response to determining that the EMB operable signal has been generated, recognizing that EMB control is able to be performed, and determining whether a failure has occurred in an EMB engine control unit (ECU); and in response to determining that a failure has occurred in one EMB ECU, determining whether the EMB vehicle has stopped driving, and in response to determining that the EMB vehicle has not stopped driving (i.e., is still driving), performing normal braking by using an different EMB that is currently in a non-failure state.

The control method may further repetitively determine whether the EMB vehicle is stopped after the performing of the normal braking by using the EMB in the non-failure state, and if the vehicle does finally stop, may inform the driver of the failure of the EMB ECU via a failure informing unit and starting initialization of the EMB in which the failure occurred.

The detecting and determining of the driver's intention to drive the vehicle may include recognizing the driver's intention to drive by detecting a combination of an IG ON signal, a door open signal, a seat load sensor signal that is generated simultaneously with the door open signal, an electro-mechanical parking brake (EPB) release signal, and a transmission lever operating signal.

Furthermore, in some exemplary embodiments of the present invention, when it is determined that the EMB operable signal is not generated, the system and method may further be configured to determine that initialization of the EMB is in progress and prevent driving of a driving motor by using a driving motor controller.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of a control system of an electro-mechanical brake system (EMB) vehicle according to an exemplary embodiment of the present invention;

FIG. 2 is a schematic view of input/output signals of a central brake controller for controlling the EMB vehicle illustrated in FIG. 1; and

FIG. 3 is a flowchart illustrating a control method of an EMB vehicle according to an exemplary embodiment of the present invention.

### DETAILED DESCRIPTION

The present invention will now be described more fully with reference to the accompanying drawings, in which exemplary embodiments of the invention are shown, so that one of ordinary skill in the art can easily embody the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The present invention relates to a control method of a vehicle equipped with an electro-mechanical brake system (EMB), whereby an engine control unit (ECU) of the EMB may be automatically initialized before a driver steps on a brake pedal, by detecting or recognizing a driver's driving will and EMB braking in a normal state where a failure of the EMB is allowed while the EMB vehicle is being driven, may be performed.

Thus, according to the present invention, when the EMB vehicle initially stops, (i.e., the instant that each EMB ECU is set to a power saving mode and a driver's intention to not drive the vehicle->is detected, the EMB ECU is automatically initialized and is set in an operation mode. Thus, power consumption can be reduced by setting the EMB ECU in the power saving mode while the EMB ECUs are not being used.

Also, initialization of the EMB requires a predetermined amount of time to determine whether the distance between a brake disc and a pad is maintained to prevent dragging, whether a failure has occurred in a motor, and whether failures have occurred in sensor input/output and CAN communications. Thus, according to the exemplary embodiment of the present invention, by detecting the driver's intention to drive the vehicle, initialization of the EMB is completed before the driver steps on a brake pedal so that the operability of the EMB can be guaranteed.

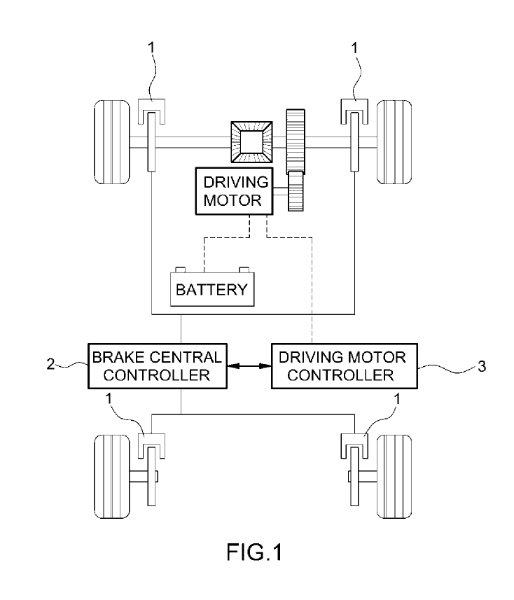

FIG. 1 illustrates a structure of a control system of an EMB vehicle according to an embodiment of the present invention. As illustrated in FIG. 1, the EMB vehicle includes generally four EMBs 1 that are connected to four wheels disposed at front, rear, right, and left sides of the vehicle, and a central brake controller 2 that controls the ECU of each EMB 1.

The central brake controller 2 may be connected to the ECU of each EMB 1 to communicate therewith, control the entire operation of the EMB 1 by using an EMB ECU, be connected to various sensor units of the EMB vehicle to communicate therewith, and receive signals from the sensor units. For example, the sensor units may include a seat load sensor and a wheel speed sensor. Also, the central brake controller 2 may be connected to a driving motor controller 3 that may be configured to control a driving motor of the EMB vehicle, via a network, to communicate with the driving motor controller 3 and control operation of the driving motor accordingly.

Each EMB 1 that is connected to each of the four wheels may also include an EMB actuator that is configured to perform a brake operation. Thus, the ECU that controls the EMB is configured to control the operation of the EMB actuator.

Each EMB ECU may be connected to the central brake controller 2 via a network to communicate with the central brake controller 2, exchanges various information with the central brake controller 2, and controls the EMB actuator by receiving signals from the central brake controller 2. As discussed above, the central brake controller may include a processor and a memory configured to store and process one or more program instructions that are configured to specifically carry out the method below. Accordingly, the entire control system and method of the EMB vehicle according to the present invention that will be described below is performed using the central brake controller 2.

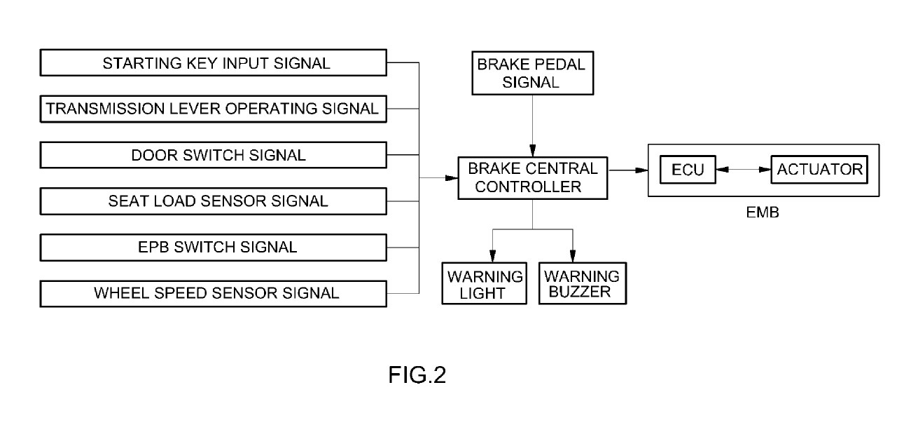

FIG. 2 is a schematic view of input/output signals of the central brake controller 2 configured to control the EMB vehicle illustrated in FIG. 1. As illustrated in FIG. 2, in order to perform a control method that will be described below, the central brake controller 2 may be configured to receive a starting key input signal, a transmission lever operating signal, a door switch signal, a seat load sensor signal (i.e., indicating that a driver is seated in the vehicle), a electro-mechanical parking brake (EPB) switch operating signal, and signals from a wheel speed sensor and a pedal sensor.

The central brake controller 2 may receive these signals and use them to begin initialization of each EMB 1 before the driver steps on a brake pedal. Also, the central brake controller 2 compensates for a brake force required by the driver by using each EMB 1 in a normal state when a failure occurs in the EMB ECU while the EMB vehicle drives.

Therefore, when a failure occurs in one of the four EMB ECUs while the EMB vehicle is being driven, the central brake controller 2 generates the brake force required by the driver by using a different EMB that is in a normal state to perform the braking operation. Each wheel is provided with a single EMG. Therefore, when there is a failure of an EMB in one wheel the other normal EMB in other wheel operates.

In this way, the system and method of compensating for the brake force required by the driver by using the alternate EMB that is in a non-failure state when a failure occurs in one of the EMB ECUs, is a well-known technique and thus descriptions thereof will be omitted. The central brake controller 2 may receive the above signals directly or receive the signals while being connected to a controller in the EMB vehicle that receives the signals via a network to communicate with the controller in the EMB vehicle.

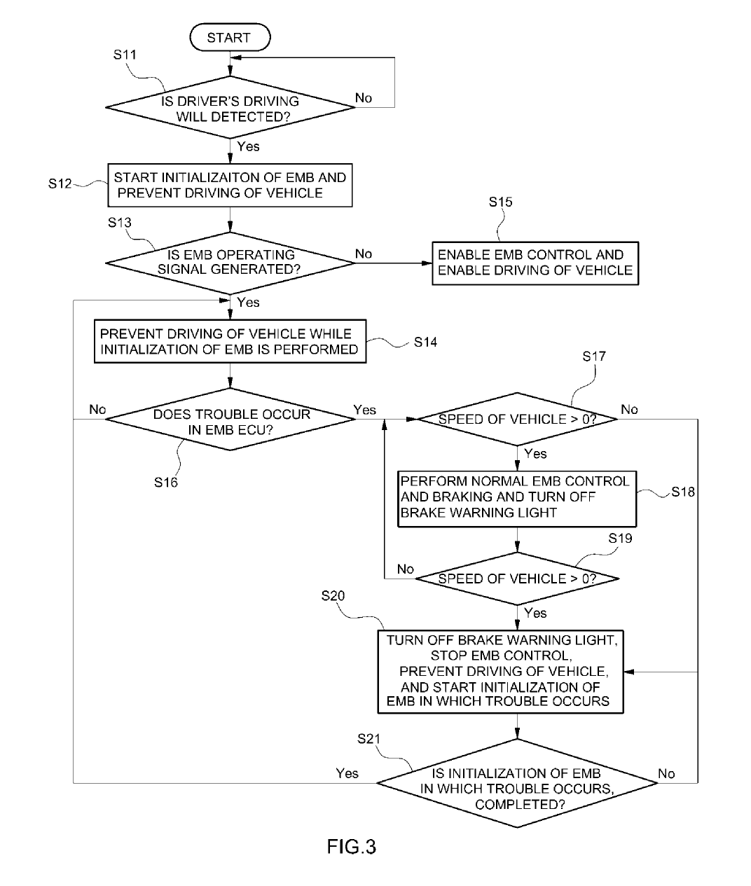

FIG. 3 is a flowchart illustrating the control method of the EMB vehicle according to an exemplary embodiment of the present invention. As illustrated in FIG. 3, the control system and method of the EMB vehicle according to the present embodiment includes detecting/determining whether or not a driver is getting ready to drive a vehicle (i.e., intends on driving) (S10).

Signals for detecting/determining the driver's driving will include an IG On signal (e.g., a starting key input signal), a door open signal (e.g., a door switch signal), a seat load sensor signal that is generated simultaneously with the door open signal (e.g., the door switch signal), an EPB release signal, and a transmission lever operating signal. In other words, the intention of the driver can be detected by based upon whether or not the IG ON signal is generated by actually starting the EMB vehicle (or by performing IG ON), the door open signal by opening a door of the EMB vehicle and simultaneously generating the seat load sensor signal in a driver's seat, by generating the EPB release signal by releasing an EPB, or by generating the transmission lever operating signal by operating a transmission lever. When the driver's intention to drive the vehicle is detected, the central brake controller 2 starts initialization of each EMB 1 and simultaneously prevents driving of a driving motor by using the driving motor controller 3 to prevent the case that the driver steps on an acceleration pedal before each EMB 1 is initialized, so that driving of the EMB vehicle can be prevented (S11).

Next, the central brake controller 2 detects that an EMB operating signal (or an EMB operable signal) is generated, and determines whether initialization of the EMB is completed (S12). If initialization of each of the four EMBs connected to each of the four wheels disposed at front, rear, right, and left sides of the EMB vehicle is completed, the central brake controller 2 recognizes that an EMB ECU can be controlled to perform EMB braking, and transmits a signal to the driving motor controller 3 to enable driving of the driving motor (i.e., to release a driving-preventing signal of the driving motor) so that the EMB vehicle can be driven (S13). When it is determined that the EMB operating signal has not been generated, it is determined that initialization of the EMB is in progress, and driving of the driving motor is prevented using the driving motor controller 3 so as to prevent driving of the EMB vehicle (S14).

The central brake controller 2 checks and determines whether a failure has occurred in the ECU of each EMB in real-time (S15), and if it is determined that a failure has occurred in the ECU of one of the four EMBs, the failure of the EMB ECU is indicated to the driver by using a warning light and/or a warning sound (e.g., by a failure informing unit). The central brake controller 2 may also be configured to control the speed of the EMB vehicle by using the wheel speed sensor before the failure of the EMB ECU is indicated to the driver, so as to detect whether the EMB vehicle is currently being driven or is stopped (S16).

If it is determined that a failure has occurred in the EMB ECU, as a result of checking the speed of the EMB vehicle, and that the EMB vehicle is being driven, the central brake controller 2 compensates for a brake force required by the driver by using an EMB that is currently in a non-failure state to perform normal EMB braking and continually does so until driving of the EMB vehicle stops (S17). In this case, a brake warning light is maintained in a turn-off state, and a brake warning sound is not generated (S17).

Next, when it is determined that the vehicle has stopped based on receiving a wheel speed sensor signal (S18), the central brake controller 2 turns on the brake warning light and generates the brake warning sound and simultaneously stops control of the EMB actuator, and prevents driving of the EMB vehicle by using the driving motor controller 3 (S19).

The central brake controller 2 turns off the EMB in which a failure occurs, and then turns on the EMB and initializes the EMB (S19). When it is determined that initialization of the EMB has been completed (S20), the central brake controller 2 recognizes that control of the EMB ECU can now be performed and transmits a signal (e.g., a driving motor driving-preventing release signal) to the driving motor controller 3 so that driving of the EMB vehicle can be performed. When the controller determines that initialization of the EMB is not completed, the central brake controller 2 maintains the brake warning light in an on state and prevents EMB control and driving of the EMB vehicle continuously.

As described above, in a control system and method of an EMB vehicle according to the exemplary embodiment of the present invention, each EMB ECU is automatically initialized by detecting a driver's intention to drive the vehicle so that the EMB ECU can be automatically set from a power saving mode to an operation mode. Thus, when each of the EMBs are not used for a long period of time, as the case during starting of the EMB vehicle once it has been stopped for a while, power consumption can be reduced using the power saving mode of the EMB ECU. In addition, in the control method and system of the EMB vehicle according to the present invention, even when a failure occurs in the EMB while the EMB vehicle is being driven, normal EMB braking can be continuously performed until the EMB vehicle is parked/stopped.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A control method of controlling a plurality of electro-mechanical brake system (EMB)s vehicle, the control method comprising:
detecting and determining, by a controller, a driver's intention to drive the vehicle;
in response to determining that the driver is intending on driving the vehicle, starting, by the controller, initialization of at least one of the plurality of EMBs;
determining, by the controller, whether the at least one EMB is operable based upon whether a signal from the EMB has been received at the controller;
in response to determining that the at least one EMB is operable, determining whether a failure has occurred in an EMB engine control unit (ECU) of that EMB; and
in response to determining that a failure has occurred, determining whether the vehicle is stopped or being driven, and when the vehicle is being driven, performing normal braking by using a different EMB that has not failed.

2. The control method of claim 1, further comprising, in response to performing normal braking by using the different EMB that has not failed, continually determining whether the vehicle has stopped, when it is determined that the vehicle has stopped, informing a driver of the failed EMB ECU via a failure informing unit and starting initialization of the EMB in which a failure occurs.

3. The control method of claim 1, wherein the detecting and determining of the driver's intention to drive the vehicle comprises determining when an IG ON signal, a door open signal, a seat load sensor signal that is generated simultaneously with the door open signal, an electro-mechanical parking brake (EPB) release signal, and a transmission lever operating signal have been received by the controller.

4. The control method of claim 1, further comprising, when the EMB operable signal is not generated, determining that initialization of the EMB is in progress and preventing driving of a driving motor via a driving motor controller.

5. A non-transitory computer readable medium containing program instructions executed by a processor or controller, the computer readable medium comprising:
program instructions that detect and determine a driver's intention to drive the vehicle;
program instructions that start initialization of at least one of the plurality of EMBs in response to a determination that the driver is intending on driving the vehicle;
program instructions that determine whether the at least one EMB is operable based upon whether a signal from the EMB has been received at the controller;
program instructions that determine whether a failure has occurred in an EMB engine control unit (ECU) of that EMB in response to determining that the at least one EMB is operable; and
program instructions that determine whether the vehicle is stopped or being driven, and when the vehicle is being driven, performing normal braking by using a different EMB that has not failed in response to determining that a failure has occurred.

6. The non-transitory computer readable medium of claim 5, further comprising, program instructions that continually determine whether the vehicle has stopped, when it is determined that the vehicle has stopped, informing a driver of the failed EMB ECU via a failure informing unit and starting initialization of the EMB in which a failure occurs in response to performing normal braking by using the different EMB that has not failed.

7. The non-transitory computer readable medium of claim 5, wherein the program instructions that detect and determine a driver's intention to drive the vehicle comprise program instructions that determine when an IG ON signal, a door open signal, a seat load sensor signal that is generated simultaneously with the door open signal, an electro-mechanical parking brake (EPB) release signal, and a transmission lever operating signal have been received by the controller.

8. The non-transitory computer readable medium of claim 5, further comprising, when the EMB operable signal is not generated, program instructions determine that initialization of the EMB is in progress and prevent driving of a driving motor via a driving motor controller.
